(19) United States
(12) Patent Application Publication
(10) Pub. No.: US 2004/0200472 A1
(43) Pub. Date: Oct. 14, 2004

(54) Method of treating functional somatic syndromes and diagnosing sleep disorders based on functional somatic syndrome symptoms

(75) Inventor: Avram Reuben Gold, Plainview, NY (US)

Correspondence Address: WEBB ZIESENHEIM LOGSDON ORKIN & HANSON, P.C., 700 KOPPERS BUILDING, 436 SEVENTH AVENUE, PITTSBURGH, PA, 15219, US

(73) Assignee: SUNY Stony Brook/Respironics

(21) Appl. No.: 10/755,038

(22) Filed: Jan. 9, 2004

Related U.S. Application Data
(60) Provisional application No. 60/438,966, filed on Jan. 9, 2003.

(51) Int. Cl. A62B 7/00

(52) U.S. Cl. 128/200.24

(57) ABSTRACT

The method of treating functional somatic syndromes includes identifying a patient as having a functional somatic syndrome or a symptom thereof and treating such a patient with an airway stabilization technique. Suitable airway stabilization techniques include positive airway pressure therapies, such as a CPAP treatment, and a mechanical airway stabilization device, such as an oral appliance, a tissue distending device, and a stimulation device. The method of diagnosing a sleep disorder includes determining whether a patient suffers from one or more symptoms of a functional somatic syndrome, and diagnosing such a patient having one or more symptoms of a functional somatic syndrome as having sleep-disordered breathing. The method may further include treating such a patient with an airway stabilization technique.

### CROSS-REFERENCE TO RELATED APPLICATIONS

This application claims the benefit of U.S. Provisional Patent Application No. 60/438,966, filed Jan. 9, 2003, which is hereby incorporated by reference in its entirety.

### BACKGROUND OF THE INVENTION

1. Field of the Invention

The present invention relates generally to a method of treating functional somatic syndromes using upper airway stabilization techniques. The present invention further relates generally to the field of sleep disorders and methods of treating sleep disorders. More specifically, the present invention relates to diagnosing a patient as having a sleep disorder based on at least one symptom commonly associated with a functional somatic syndrome and treating the sleep disorder with an upper airway stabilizing technique.

2. Description of the Related Art

During the past decade, physicians treating sleep disorders have experienced a broadening of the spectrum of sleep-disordered breathing. In addition to obstructive sleep apnea/hypopnea syndrome (OSA/H), many researchers and clinicians now recognize a new syndrome—upper airway resistance syndrome (UARS). Both OSA/H and UARS are manifested with the signs/symptoms of snoring, fitful sleep, and daytime sleepiness/fatigue. The chief difference between the two syndromes is found in the level of inspiratory airflow during sleep. While patients with both syndromes experience recurrent arousal from sleep, OSA/H patients demonstrate decreases of inspiratory airflow to less than 50% of waking levels, while patients with UARS have less severe inspiratory airflow limitation. Recent research indicates that UARS is associated with a less collapsible upper airway.

When viewed from the perspective of upper airway physiology, patients with UARS and patients with OSA/H are similar, differing only in the severity of their upper airway collapse during sleep. However, recent evidence in the field suggests that patients with UARS have a different clinical presentation from patients with OSA/H. Patients with UARS generally exhibit somewhat different symptoms/signs than do OSA/H patients and generally break down along different demographic lines than do OSA/H patients. Additionally, UARS patients demonstrate alpha-delta sleep, which is not known to be a feature of OSA/H syndrome. Alpha-delta sleep may be defined as the intrusion of waking alpha rhythm into deep, slow-wave sleep. Alpha-delta sleep has been observed in a variety of syndromes associated with chronic fatigue, also referred to as functional somatic syndromes (FSS).

Functional somatic syndromes (FSS) may be defined as physical syndromes without an organic disease explanation, demonstrable structural changes, or established biochemical abnormalities. Thus, patients suffering from functional somatic syndromes are characterized more by symptoms, suffering, and disability than by consistently demonstrable tissue abnormalities. Functional somatic syndromes are thought to be multiaxial syndromes in which psychological factors (depression), neurological factors (increased pain sensitivity), hormonal factors (orthostatic hypotension and alterations in the hypothalamic-pituitary adrenal axis), and sleep-related factors (frequent arousal and alpha frequency intrusion into sleep) interact to produce a complex clinical presentation. The functional somatic syndromes generally include: chronic fatigue syndrome, fibromyalgia, irritable bowel syndrome, migraine/tension headaches, and temporomandibular joint syndrome. Other examples of functional somatic syndromes are thought to include: premenstrual syndrome, multiple chemical sensitivity, sick building syndrome, repetition stress injury, side effects of silicone breast implants, Gulf War syndrome, chronic whiplash, restless leg/periodic limb movement syndrome, and like ailments. The functional somatic syndromes generally affect female patients more often than male and tend to overlap and share many common symptoms/signs.

The current standard for treating functional somatic syndromes is through the use of drugs, physical therapy, and/or psychotherapy, which are directed primarily at the functional somatic syndrome symptoms. These treatment techniques, however, each have disadvantages and have limited efficacy in treating the conditions causing the symptoms. For example, drugs may not be tolerated by certain patients and often require long-term use. Physical therapy is time consuming, often painful, and is limited to those patients who have sufficient mobility to receive this form of treatment. Finally, many patients may be resistive to the use of psychotherapy, and it is not clear whether it is effective for many patients. In addition, psychotherapy fails to address any underlying condition that the patient may have. All of these conventional treatments focus on treating only the symptoms of the functional somatic syndrome.

In addition to a common symptom of excessive sleepiness/fatigue, functional somatic syndromes feature other symptoms/signs such as: chronic fatigue, irritable bowel, migraine/tension headaches, temporomandibular joint pain, premenstrual pain, sleep-onset insomnia, sleep maintenance insomnia, unrefreshing sleep, EEG evidence of sleep fragmentation, bruxism, muscle pain, muscle tenderness, gastroesophageal reflux (i.e., heartburn), abdominal pain, abdominal urgency, diarrhea, depression, orthostatic syncope, and alpha-delta sleep.

### SUMMARY OF THE INVENTION

The inventors have observed in clinical studies that UARS patients are known to exhibit one or more of the aforementioned symptoms/signs found in patients with functional somatic syndromes. In particular, UARS patients often exhibit one or more symptoms/signs common to functional somatic syndromes, including, but not limited to, sleep-onset insomnia, headaches, irritable bowel, gastroesophageal reflux (i.e., heartburn), depression, bruxism, and alpha-delta sleep. Other symptoms/signs found in UARS patients include rhinitis, hypothyroidism, and asthma.

In view of the foregoing, the similarity in symptoms/signs between UARS and FSS patients has led the inventors to conclude that unrecognized inspiratory airflow limitation during sleep, such as that which takes place in UARS, likely plays a role in the development of functional somatic syndromes. Specifically, the frequent arousal and alpha wave intrusion into sleep of patients with functional somatic syndromes and the nonrestorative sleep associated with functional somatic syndromes is likely the result of impaired inspiratory airflow during sleep. Thus, treatment of inspiratory airflow limitation during sleep is likely to be effective in treating functional somatic syndromes. Additionally, the symptoms/signs associated with functional somatic syndromes may be useful in diagnosing sleep disorders such as OSA/H and UARS. Accordingly, one object of the present invention is to provide a method of treating functional somatic syndromes by correcting inspiratory airflow limitation during sleep. Another object of the present invention is to provide a method of treating functional somatic syndromes that overcomes the shortcomings of conventional treatment techniques aimed at treating the individual symptoms/signs of functional somatic syndromes. A further object of the present invention is to provide a method of diagnosing sleep disorders, such as OSA/H and UARS, based on symptoms/signs commonly associated with functional somatic syndromes.

The foregoing objects are achieved by a method of treating functional somatic syndromes in accordance with the present invention. The method generally includes identifying a patient as having a functional somatic syndrome or identifying one or more symptoms of a functional somatic syndrome, and treating such a patient with an airway stabilization technique. The airway stabilization technique may include stabilizing the airway with a mechanical stabilization. The mechanical stabilization may be an oral appliance adapted to control a position of an anatomical feature of a patient, a tissue distending device adapted to be located externally and coupled to such a patient so as to distend tissue associated with such a patient's airway, or a stimulation device adapted to apply a stimulating energy to a patient. The airway stabilization technique may further include stabilizing the airway with positive airway pressure therapy. The positive airway pressure therapy may be continuous positive airway pressure, bi-level positive airway pressure, or auto-titrating positive airway pressure.

The patient may be identified as having a functional somatic syndrome by identifying a symptom of the functional somatic syndrome. The symptoms may include: chronic fatigue, irritable bowel, migraine headaches, tension headaches, temporomandibular joint pain, premenstrual pain, sleep-onset insomnia, sleep maintenance insomnia, unrefreshing sleep, EEG evidence of sleep fragmentation, bruxism, muscle pain, muscle tenderness, heartburn, abdominal pain, abdominal urgency, diarrhea, depression, orthostatic syncope, alpha-delta sleep.

The method may further include monitoring the patient for an inspiratory airflow limitation during sleep. The patient may be categorized based on the inspiratory airflow limitation. For example, the patient may be categorized as having upper airway resistance syndrome (UARS) if the inspiratory airflow is approximately fifty-one to one-hundred percent of waking levels as an upper airway resistance syndrome (UARS) patient. The patient may be categorized as having obstructive sleep apnea/hypopnea (OSA/H) if the inspiratory airflow is approximately zero to fifty percent of waking levels as an obstructive sleep apnea/hypopnea (OSA/H) patient. The method may further include observing the alpha-delta sleep of such a patient to diagnose the functional somatic syndrome.

The functional somatic syndrome of the patient may include any one or more of the following syndromes: chronic fatigue syndrome, fibromyalgia, irritable bowel syndrome, migraine headaches, tension headaches, temporomandibular joint syndrome, Gulf War syndrome, premenstrual syndrome, sleep-onset insomnia, sleep maintenance insomnia, multiple chemical sensitivity, sick building syndrome, repetition stress injury, side effects of silicone breast implants, chronic whiplash and restless leg/periodic limb movement syndrome.

In another embodiment, the present invention is a method of diagnosing a sleep disorder. The diagnosing method generally includes determining whether a patient suffers from one or more symptoms of a functional somatic syndrome, and diagnosing such a patient as having sleep-disordered breathing. The diagnosed patient may be treated with an airway stabilization technique in accordance with the present invention.

The patient may be diagnosed as having obstructive sleep apnea/hypopnea (OSA/H) or upper airway resistance syndrome (UARS) based on whether alpha-delta sleep is present in the patient's sleep cycle. For example, the patient may be diagnosed with moderate to severe obstructive sleep apnea/hypopnea (OSA/H) if alpha-delta sleep is not substantially present, and may then be treated with an airway stabilization technique. Alternatively, the patient may be diagnosed as having upper airway resistance syndrome (UARS) or mild to moderate obstructive sleep apnea/hypopnea (OSA/H) if alpha-delta sleep is substantially present, and may then be treated with an airway stabilization technique.

The airway stabilization technique may include stabilizing the patient's airway with a mechanical stabilization. The mechanical stabilization may include an oral appliance adapted to control a position of an anatomical feature of a patient, a tissue distending device adapted to be located externally and coupled to such a patient so as to distend tissue associated with such a patient's airway, or a stimulation device adapted to apply a stimulating energy to a patient. The airway stabilization technique may also include stabilizing the airway with positive airway pressure therapy. The positive airway pressure therapy may include continuous positive airway pressure, bi-level positive airway pressure, or auto-titrating positive airway pressure.

The diagnosing step of the method may be based on one or more symptoms of a functional somatic syndrome, such as chronic fatigue, irritable bowel, migraine headaches, tension headaches, temporomandibular joint pain, premenstrual pain, sleep-onset insomnia, sleep maintenance insomnia, unrefreshing sleep, EEG evidence of sleep fragmentation, bruxism, muscle pain, muscle tenderness, heartburn, abdominal pain, abdominal urgency, diarrhea, depression, orthostatic syncope, and alpha-delta sleep.

The features and characteristics of the present invention will become more apparent upon consideration of the following description and the appended claims with reference to the accompanying drawing, which forms part of this specification. It is to be expressly understood, however, that the drawing is for the purpose of illustration and description only and is not intended as a definition of the limits of the invention.

### BRIEF DESCRIPTION OF THE DRAWINGS

FIG. 1 is a bar chart showing the percentage of UARS and OSA/H patients that exhibit eleven pre-selected symptoms/signs of sleep-disordered breathing.

### DETAILED DESCRIPTION OF THE INVENTION

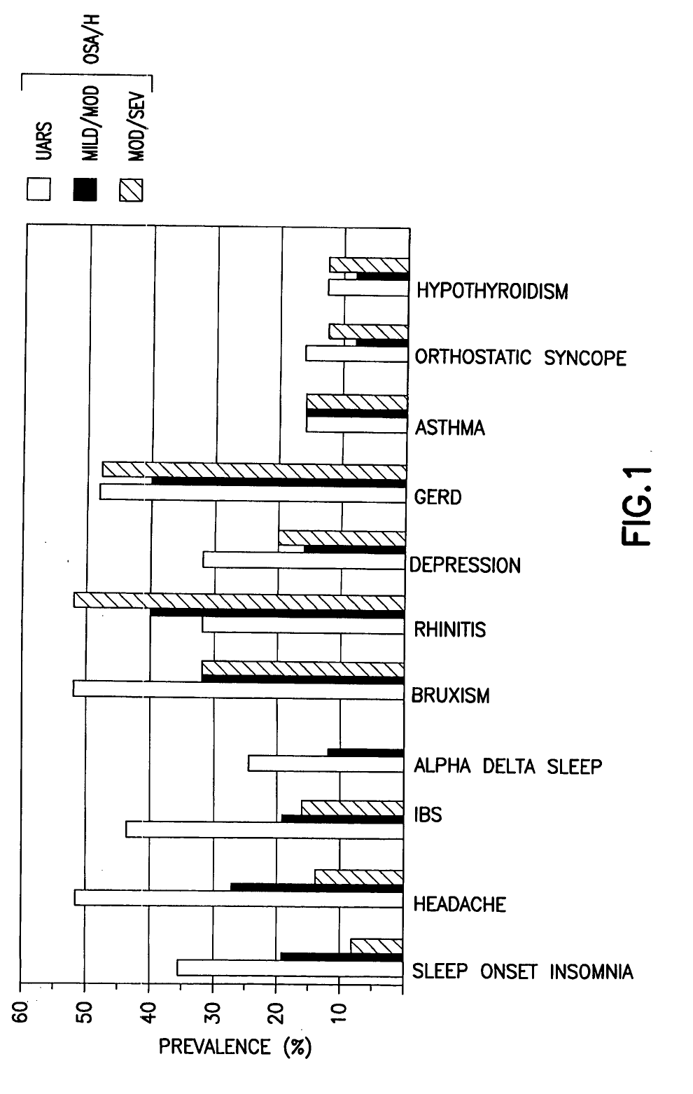

As indicated previously, both OSA/H and UARS patient manifest several similar outward symptoms, including snoring, fitful sleep, and daytime sleepiness/fatigue. Additionally, as indicated previously, the inventors have observed that UARS patients share one or more symptoms/signs found in patients with functional somatic syndromes. In particular, UARS patients often exhibit one or more symptoms/signs common to functional somatic syndromes, including sleep-onset insomnia, headaches, irritable bowel, gastroesophageal reflux (i.e., heartburn), depression, bruxism, and alpha-delta sleep. FIG. 1 is a chart comparing the prevalence of these particular symptoms/signs in patients with OSA/H with the prevalence of the same symptoms/signs in patients with UARS, as well as other symptoms/signs associated with these sleep disorders. FIG. 1 illustrates the general higher prevalence of functional somatic syndrome symptoms in UARS patients than OSA/H patients. However, FIG. 1 further illustrates that, while UARS patients exhibit a higher percentage of certain functional somatic syndrome symptoms/signs than do OSA/H patients, OSA/H patients (either mild/moderate or moderate/severe) also exhibit at least these particular symptoms/signs associated with functional somatic syndromes. Thus, the inventors have determined that the symptoms/signs associated with functional somatic syndromes may be used as a key to identifying both OSA/H and UARS sleep disorders in accordance with the present invention. Moreover, the present invention applies the inventors' discovery of the similarity of symptoms/signs associated with UARS and functional somatic syndromes as a basis for treating functional somatic syndromes.

As indicated previously, the upper airway physiology of patients with UARS and patients with OSA/H are similar, differing only in the severity of their upper airway collapse during sleep. However, FIG. 1 indicates that UARS patients appear to have a different clinical presentation than patients with OSA/H. Patients with UARS generally exhibit different symptoms/signs than do OSA/H patients and generally break down along different demographic lines than do OSA/H patients. The chief difference between UARS and OSA/H is found in the level of inspiratory airflow during sleep. While patients with both syndromes experience recurrent arousal from sleep, OSA/H patients demonstrate decreases of inspiratory airflow to less than 50% of waking levels, while patients with UARS have less severe inspiratory airflow limitation. Additionally, alpha-delta sleep is generally a characteristic of UARS and functional somatic syndromes, but is generally absent in moderate to severe OSA/H patients.

Polysomnograms of UARS and OSA/H patients indicate that OSA/H patients demonstrate inspiratory airflow of less than fifty percent of waking levels associated with oxyhemoglobin desaturation. Patients with UARS have less severe inspiratory flow limitation, such as an inspiratory airflow of approximately fifty-one to one hundred percent of waking levels, due to a less collapsible upper airway. In both cases, inspiratory airflow is limited to some degree, and it is this limitation that is believed by the inventors to be a contributing cause in the development of functional somatic syndromes. Specifically, the frequent arousal and alpha wave intrusion into sleep of patients with functional somatic syndromes and the non-restorative sleep associated with functional somatic syndromes is believed by the inventors to be a result of impaired inspiratory airflow during sleep. Thus, treatment of inspiratory airflow limitation during sleep is likely to be effective in treating functional somatic syndromes.

As indicated previously, the functional somatic syndromes generally include chronic fatigue syndrome, fibromyalgia, irritable bowel syndrome, migraine/tension headaches, temporomandibular joint syndrome, pre-menstrual syndrome, multiple chemical sensitivity, sick-building syndrome, repetition stress injury, side effects of silicone breast implants, Gulf War Syndrome, chronic whiplash, restless leg/periodic limb movement syndrome and like ailments. In addition to a common symptom of excessive sleepiness/fatigue, functional somatic syndromes feature other symptoms/signs such as: chronic fatigue, irritable bowel, migraine/tension headaches, temporomandibular joint pain, premenstrual pain, sleep-onset insomnia, sleep maintenance insomnia, unrefreshing sleep, EEG evidence of sleep fragmentation, bruxism, muscle pain, muscle tenderness, gastroesophageal reflux (i.e., heartburn), abdominal pain, abdominal urgency, diarrhea, depression, orthostatic syncope, and alpha-delta sleep.

In view of the foregoing, it will be apparent that the symptoms/signs of functional somatic syndromes overlap, at least in part, the symptoms/signs of UARS and OSA/H. In particular, as FIG. 1 shows, a particular overlap is present with sleep-onset insomnia, migraine/tension headaches, irritable bowel syndrome, bruxism, and depression. The present invention provides a method of stabilizing the upper airway of the patient as a treatment for functional somatic syndromes. In particular, the present invention generally includes identifying a functional somatic syndrome or symptoms thereof in a patient, and treating the patient with an upper airway stabilization device or technique. The presence of a functional somatic syndrome or one or more symptoms thereof may be used as a basis for diagnosing sleep disorders such as UARS and OSA/H, in accordance with the present invention, as discussed further herein.

The airway stabilization technique may take the form of a mechanical stabilization device or a positive airway pressure device adapted to deliver positive pressure therapy to the patient. Positive airway pressure devices generally include continuous positive airway pressure (CPAP) devices that deliver a continuous flow of gas at a constant pressure, bi-level positive airway pressure support devices in which the pressure of gas delivered to the patient varies with the patient's breathing cycle, and an auto-titrating positive airway pressure device in which the pressure of the flow of breathing gas provided to the patient changes based on the detected conditions of the patient, such as whether the patient is snoring or experiencing an apnea, hypopnea, or upper airway resistance.

Examples of CPAP devices include the REMstar® and Solo® family of CPAP devices manufactured and distributed by Respironics, Inc. of Pittsburgh, Pa. A bi-level pressure support system provides an inspiratory positive airway pressure (IPAP) that is greater than an expiratory positive airway pressure (EPAP), which the pressure is delivered during the patient's expiratory phase. Such a bi-level mode of pressure support is provided by the BiPAP® family of devices manufactured and distributed by Respironics, Inc. and is taught, for example, in U.S. Pat. No. 5,148,802 to Sanders et al., U.S. Pat. No. 5,313,937 to Zdrojkowski et al., U.S. Pat. No. 5,433,193 to Sanders et al., U.S. Pat. No. 5,632,269 to Zdrojkowski et al., U.S. Pat. No. 5,803,065 to Zdrojkowski et al., and U.S. Pat. No. 6,029,664 to Zdrojkowski et al., the contents of each of which are incorporated by reference into the present invention.

An example of an auto-titrating device that adjusts the pressure delivered to the patient based on whether or not the patient is snoring is the Virtuosos CPAP family of devices manufactured and distributed by Respironics, Inc. This type of auto-titration device is taught, for example, in U.S. Pat. Nos. 5,203,343; 5,458,137; and 6,087,747 all to Axe et al., the contents of which are incorporated herein by reference. Examples of conventional auto-titration pressure support systems are disclosed in U.S. Pat. No. 5,245,995 to Sullivan et al.; U.S. Pat. Nos. 5,259,373; 5,549,106, and 5,845,636 all to Gruenke et al.; U.S. Pat. Nos. 5,458,137 and 6,058,747 both to Axe et al.; U.S. Pat. Nos. 5,704,345; 6,029,665, and 6,138,675 all to Berthon-Jones; U.S. Pat. No. 5,645,053 to Remmers et al.; and U.S. Pat. Nos. 5,335,654, 5,490,502, 5,535,739, and 5,803,066 all to Rapoport et al.

Other modes of providing positive airway pressure support to a patient that is suitable for use in stabilizing a patient's airway in accordance with the present invention include, for example, proportional assist ventilation (PAV®), which is a mode of pressure support in which the pressure of gas delivered to the patient varies with the patient's breathing effort to increase the comfort to the patient. U.S. Pat. Nos. 5,044,362 and 5,107,830 both to Younes, the contents of which are incorporated herein by reference, teach a positive airway pressure support device capable of operating in a PAV® mode. In addition, proportional positive airway pressure (PPAP) devices deliver breathing gas to the patient based on the flow generated by the patient. U.S. Pat. Nos. 5,535,738, 5,794,615, and 6,105,573 all to Estes et al., the contents of which are incorporated herein by reference, teach a positive airway pressure support device capable of operating in a PPAP mode.

Examples of mechanical devices that serve to stabilize the airway include oral appliances that controls or adjusts a position of an anatomical feature of a patient, such a mandibular positing device, a soft pallet lifting device, and a tongue positing or advancement device. Another mechanical device suitable for stabilizing a patient's airway in accordance with the present invention includes devices that apply a negative pressure or a distending force to the exterior of the patient, for example, in the neck region, to maintain the airway in an open condition. An additional example of a mechanical device suitable for stabilizing a patient's airway in accordance with the present invention includes a stimulation device that applies a stimulating energy, such as an electrical or magnetic stimulation, to the patient to maintain the patency of the patient's airway.

An example of an oral appliance that controls a position of an anatomical feature of a patient from within the oral cavity to stabilize the patient's airway is disclosed in PCT Application No. PCT/US01/01874 (Pub. No. WO 01/52928). More specifically, this PCT application discloses airway stabilization techniques by controlling the position of the tongue, the soft palate, the mandible, or any combination thereof. Other patents that teach airway stabilization via an oral appliance that controls the position of an anatomical feature of a patient include: U.S. Pat. No. 3,132,647 to Corniello; U.S. Pat. No. 4,169,473 to Samelson; U.S. Pat. No. 4,196,724 to Wirt et al.; U.S. Pat. No. 4,676,240 to Garty; U.S. Pat. No. 4,901,737 to Toone; U.S. Pat. No. 5,056,534 to Wright; U.S. Pat. No. 5,154,184 to Alvarez; U.S. Pat. No. 5,373,859 to Formey; U.S. Pat. No. 5,409,017 to Lowe; U.S. Pat. No. 5,826,579 to Remmers et al.; U.S. Pat. No. 5,868,138 to Halstrom; U.S. Pat. No. 5,915,385 to Hakimi; U.S. Pat. No. 5,988,171 to Sohn et al.; and U.S. Pat. No. 6,092,523 to Belfer, all of which are incorporated herein by reference. An additional example of an oral appliance adapted to control the position of an anatomical feature of a patient is a palate expander, often used in children for orthodontic purposes.

An example of a device that applies a negative pressure or a distending force to exterior of the patient is disclosed in U.S. Pat. No. 5,343,878 to Scarberry et al., incorporated herein by reference. According to this technique, a distending force is applied to the external surface of the patient via, for example, a negative pressure or an adhesive, to pull open the patient's airway, thereby stabilizing it and preventing its collapse.

Examples of devices that apply an electrical stimulation, either internally or externally, to the patient to maintain the patency of the patient's airway are disclosed in U.S. Pat. No. 6,212,435 to Lattner et al.; U.S. Pat. No. 4,830,008 to Meer; U.S. Pat. No. 5,123,425 to Shannon et al.; U.S. Pat. No. 5,146,918 to Kallok et al.; U.S. Pat. No. 5,190,053 to Meer; U.S. Pat. No. 5,591,216 to Testerman et al.; and U.S. Pat. No. 5,522,862 to Testerman et al., all incorporated herein by reference. An example of a device that applies magnetic stimulation to maintain the patency of the patient's airway is disclosed in published PCT Application No. PCT/US98/21864 (Pub. No. WO 99/20339). An example of a device that uses an implanted microstimulator is also disclosed in this PCT application, as well as in U.S. Pat. No. 6,240,316 to Richmond et al., which are both incorporated herein by reference.

In view of the foregoing, it can be appreciated that the present invention contemplates using any airway stabilization technique, e.g., positive airway pressure support or mechanical airway support, as part of a method of treating functional somatic syndromes. In addition, multiple airway stabilization techniques may be used in combination, such as the combination of a CPAP therapy and a tongue-positioning device, to treat a functional somatic syndrome and symptoms thereof in a patient. The present invention is not intended to be limited to the airway stabilization techniques described previously, nor is this listing intended to be exhaustive. In addition, as new airway stabilization techniques are developed in the field, including surgical and pharmacological solutions, they may be equally suitable for use in the present method.

The following example illustrates how UARS, OSA/H, and functional somatic syndromes are believed to be related from a treatment standpoint, and how the symptoms of functional somatic syndrome may be used as a basis for diagnosing sleep disorders in accordance with the present invention.

### EXAMPLE I

The present inventors conducted a study in which seventy-five patients (75) with UARS and OSA/H were selected for the study. Twenty-five (25) UARS patients had an apnea/hypopnea index (AHI) of less than 10/h. Twenty-five (25) patients had mild to moderate OSA/H and an AHI of greater than or equal to 10/h but less than 40/h. Twenty-five (25) patients had moderate to severe OSA/H and an AHI greater than or equal to 40/h.

Patients underwent comprehensive medical histories, physical examinations, and full-night polysomnography. The diagnosis of UARS included quantitative measurement of inspiratory airflow and inspiratory effort with demonstration of inspiratory airflow limitation during sleep. The percentage of women among the patients with sleep-disordered breathing (p=0.001) and the prevalence of sleep-onset insomnia (p=0.04), headaches (p=0.01), irritable bowel syndrome (p=0.01), and alpha-delta sleep (p=0.01) was correlated with decreasing AHI. The diagnostic methods used to established the diagnosis of UARS and OSA/H and the methods used to compare the symptoms between the three groups of sleep-disordered breathing patients follow.

All of the patients referred were included in the survey because of a clinical suspicion of sleep-disordered breathing. Patients with fibromyalgia referred for evaluation of sleep-disordered breathing were excluded because they would be expected to have the symptoms of the functional somatic syndromes. On scheduling a sleep consultation, each patient received a detailed general medical history questionnaire and a sleep-related symptom questionnaire to complete and bring to the consultation. The sleep consultation was performed by a physician with credentials in both internal medicine and sleep medicine, and included a general medical and sleep-related history and physical examination.

Polysomnography was performed between the hours of 10:00 PM and 6:00 AM. Sleep stages were monitored using surface EEG activity of the central and occipital regions, submental surface electromyographic activity, and left and right electro-oculographic activity. Leg movement was detected using surface electromyographic activity of the right and left tibialis anterior muscle. Airflow at the nose and mouth was monitored with a thermocouple. Thoracoabdominal movement was monitored with piezoelectric belts. Oxyhemoglobin saturation was monitored at the finger using a pulse oximeter. A continuous ECG monitored heart rate and rhythm. All of the data were converted from analog to digital and stored on a computer for analysis by a board-certified sleep physician.

Respiratory events were defined as any combination of apnea and hypopnea lasting at least 10 seconds and associated with an arousal. Apnea was defined as a decrease of inspiratory airflow to less than 20% of waking levels, and hypopnea was defined as a decrease in inspiratory airflow to less than 50% of waking levels. The clinical diagnosis of OSA/H was established by an apnea/hypopnea index (AHI) of at least ten events per hour of sleep. Patients presenting with symptoms of sleep-disordered breathing, but with an AHI of less than 10/h received a presumptive diagnosis of UARS. The diagnosis of UARS was confirmed after further evaluation with a diagnostic nasal continuous positive airway pressure study.

All patients with a presumptive diagnosis of UARS underwent a nasal CPAP study to demonstrate inspiratory airflow limitation during non-rapid eye movement (NREM) sleep (confirming UARS) and to determine a therapeutic level of nasal CPAP.

During the nasal CPAP study, each patient slept wearing a nasal CPAP mask available commercially from Respironics, Inc., Murrysville, Pa. The mask was attached via a breathing circuit and a bi-directional valve to a pressure support system capable of administering a positive airway pressure, such as a CPAP device, and to a source of negative pressure, such as a modified REMstar® brand CPAP unit also commercially available from Respironics, Inc. Using the dual pressure sources, the present inventor was able to vary the mask pressure between −20 cm H₂O and 20 cm H₂O. The monitoring of sleep stages, leg movements, heart rhythm, and oxyhemoglobin saturation during the nasal CPAP study was the same as for polysomnography.

Nasal airflow was measured with a heated pneumotachograph, such as a Model 3813, commercially available from Hans Rudolph, Kansas City, Mo. and transducer Model MP45-14-871, S/N 45534, commercially available from Validyne Engineering, Northridge, Calif. interposed between the bi-directional valve and the nasal mask. Inspiratory effort was measured as esophageal pressure using a saline solution-filled infant feeding tube with side ports at its distal 1 cm attached to a disposable pressure transducer, such as a Model 00-041576504A, commercially available from Maxxim, Athens, Tex. The distal 1 cm of the feeding tube was positioned in the middle third of the esophagus. Nasal mask pressure (Pmask) was monitored directly from a port in the mask using a differential pressure transducer (Model 231D, Spectramed, Oxnard, Calif.) referenced to atmosphere.

To demonstrate sleep related inspiratory flow limitation, Pmask is set at atmospheric pressure (between 1 cm H₂O and −1 cm H₂O). Inspiratory flow limitation is considered to occur when inspiratory airflow becomes maximal despite an increasing driving pressure for airflow (a decreasing esophageal pressure). The combination of excessive daytime sleepiness/fatigue, an AHI less than 10/h, and evidence of inspiratory flow limitation during NREM sleep with Pmask at atmospheric pressure establishes the diagnosis of UARS.

The following symptoms/signs associated with functional somatic syndromes were investigated during the study:

Sleep-onset insomnia: a subjective inability to fall asleep in less than 30 min.;

Headaches: a diagnosis of migraine headaches established by a physician or the occurrence of any headache (other than a morning headache on awakening) at least once weekly;

Rhinitis: any two of the following: the presence of chronic nasal stuffiness, the presence of chronic postnasal drip, the presence of chronic or seasonal nasal allergies;

Gastroesophageal reflux: a diagnosis of gastroesophageal reflux established by a physician or the presence of heartburn (every week) for which the patient regularly receives antacids or histamine type-2 blocking agents;

Asthma: a diagnosis of asthma established by a physician or the presence of wheezing during a physical examination of a nonsmoker;

Depression: the diagnosis of depression by a psychiatrist or psychologist, or the diagnosis by an internist associated with the prescription of antidepressant medication;

Hypothyroidism: diagnosed by a physician and treated with thyroid replacement;

Bruxism: the observation by a bed partner of “tooth grinding” or the observation by a dentist of the characteristic of tooth wear;

Alpha-delta sleep: a polysomnographic EEG pattern characterized by the superimposition of alpha rhythm on the delta rhythm of slow-wave sleep. The presence of alpha-delta sleep was determined by a board-certified sleep physician evaluating the full-night polysomnogram (first-sleep study);

IBS: a diagnosis of IBS established by a physician or the regular occurrence of two of the following symptoms: diarrhea alternating with constipation, abdominal pain/urgency, or gaseous bloating;

Orthostatic syncope: the frequent experiencing of “light headedness” (not a sensation of “spinning”) on arising from a seated or supine position in a patient not being treated with diuretics or antihypertensives.

Only current symptoms/signs were considered present. Symptoms/signs that had been experienced prior to the consultation, but that did not continue, were considered absent.

To ensure a broad range of sleep-disordered breathing severity in the patients, the inventor collected 25 consecutive patients at each of three levels of severity of AHI UARS (AHI less than 10/r), mild-to-moderate OSA/H (AHI less than or equal to 10 to less than 40/h), and moderate-to-severe OSA/H (AHI less than or equal to 40/h). Each patient's questionnaires, history, physical examination, and polysomnogram were reviewed to abstract the needed information. Whenever it was determined that information was missing, the physician who performed the consultation obtained the missing information during the next clinical contact (usually within one month of polysomnography). The designation of symptoms/signs as “present” or “absent” according to the criteria listed above was done by individuals blinded to the severity of the patient's sleep-disordered breathing.

Demographic differences between groups were tested on continuous outcomes with one-way analysis of variance. Differences on categorical outcomes were tested with the X2 statistic. The correlation between the prevalence of the specified symptoms/signs and decreasing severity of AHI grouping was tested nonparametrically with the Cochran-Mantel-Haonszel (CMH) test of zero correlation. A statistically significant p value would indicate a significant positive or negative correlation between prevalence of a symptom/sign and decreasing severity of AHI group.

The anthropometric and AH1 data of three groups of patients with sleep-disordered breathing are shown in Table 1.

TABLE 1
Anthropometric and AHI Data*

| | | Mild to-Moderate | Moderate-to-Severe |
|---|---|---|---|
| Variables | UARS | OSA/H | OSA/H |
| Age, yr | 43 (15)† | 52 (13) | 48 (14) |
| BMI | 29.9 (6)†† | 35.6 (9) | 38.4 (8) |
| Male/female gender | 13/12†† | 5/20 | 2/23 |
| AHI, events/h | 1.5 (8.3) | 25.1 (10.2) | 68.8 (17.4) |

*Data are presented as mean (SD) or No.
†p = 0.036 vs. mild-to-moderate OSA/H group.
††p < 0.02 vs. both OSA/H groups.

The patients with UARS were significantly younger than the patients with mild-to-moderate OSA/H (p=0.036), but were not significantly younger than the patients with moderate-to-severe OSA/H. The patients with UARS had a significantly lower body mass index (BMI) than either group of patients with OSA/H (p<0.02 for each comparison). Female patients constituted a significantly larger portion of the UARS group than of either OSA/H group (p<0.02 for each comparison), with the prevalence of women among the patients progressively decreasing as the severity of AHI group increased (p=0.0005, CMH test of zero correlation).

The sleep-related symptoms of the 75 patients are shown in Table 2.

TABLE 2
Sleep-Related Symptoms*

| | | Mild to-Moderate | Moderate-to-Severe |
|---|---|---|---|
| Variables | UARS | OSA/H | OSA/H |
| Sleepiness/fatigue | 25 (100) | 23 (92) | 25 (100) |
| Snoring | 22 (88) | 25 (100) | 25 (100) |
| Witnessed apnea | 9 (36) | 16 (64) | 21 (84) |
| Fitful, restless sleep | 16 (64) | 17 (68) | 16 (64) |

*Data are presented as No. (% of group).

Nearly all of the patients had complaints of both sleepiness/fatigue and snoring. The three patients with UARS who did not have a history of snoring presented with sleepiness/fatigue and fitful, restless sleep. The two patients with mild-to-moderate OSA/H who did not complain of sleepiness/fatigue both had histories of snoring and witnessed apnea.

The study identified a relationship between the decreasing severity of AHI group and the prevalence of symptoms/signs of sleep-disordered breathing. There was a significant correlation between decreasing severity of AHI group and the prevalence of sleep-onset insomnia (p=0.04), headache (p=0.01), IBS (p=0.01), and alpha-delta sleep (p=0.01). Non-significant trends were present for the prevalence of bruxism (p=0.16) and rhinitis (p=0.16). Unlike the symptoms/signs that increased in prevalence with decreasing severity of AHI, the prevalence of rhinitis tended to decrease as severity of AHI decreased. There was no significant correlation between the prevalence of depression, GERD, asthma, hypothyroidism, or orthostatic syncope and the severity of AHI.

Alpha-delta sleep was present in six of the patients with UARS (8.9±8.5% of total sleep time), in three patients with mild-to-moderate OSA/H (13.7±7.4% of total sleep time), and in none of the patients with moderate-to-severe OSA/H. In patients with alpha-delta sleep, the finding was present in all slow-wave sleep observed during polysomnography. Furthermore, each patient with alpha-delta sleep during full-night polysomnography also had the finding during the CPAP study. Each patient without alpha-delta sleep during polysomnography did not display alpha-delta sleep during the CPAP study.

To evaluate whether the symptoms/signs whose prevalence were greatest in patients with UARS were widely distributed among those patients, or whether they were clustered in a small group of patients with numerous symptoms/signs, the present inventor chose five symptoms/signs that tended to be most prevalent in patients with UARS, including sleep-onset insomnia, headache, IBS, alpha-delta sleep, and bruxism (FIG. 1), and counted the frequency of these symptoms/signs in each patient with sleep-disordered breathing. It was found that the five symptoms/signs tended to be widely distributed among patients with UARS. More than 96% of the patients with UARS had at least one symptom/sign, with 72% having from two to four symptoms/signs. Despite their decreased prevalence, the symptoms/signs were also widely distributed among patients with OSA/H, with 64% having at least one symptom/sign. Thus, the symptoms/signs that tended to be more prevalent in patients with UARS were broadly distributed among patients with sleep-disordered breathing and not just clustered in a small subset of patients with numerous symptoms/signs.

In the foregoing example, a relationship has generally been identified between the severity of sleep disordered breathing and the prevalence of a variety of symptoms/signs associated with functional somatic syndromes. The foregoing example indicates that the percentage of women, and the prevalence of sleep-onset insomnia, headache, irritable bowel syndrome, and alpha-delta sleep are high among patients with UARS and decrease progressively with increasing severity of sleep disordered breathing. The symptoms/signs appear to be widely distributed among patients with sleep-disordered breathing rather than restricted to a particular sub-group. The foregoing example generally confirms the inventor's hypothesis that UARS differs from moderate-to-severe OSA/H and its symptoms/signs, and shares common symptoms/signs with functional somatic syndromes. Nonetheless, as indicated previously OSA/H patients do exhibit, to a lesser degree, similar symptoms/signs to those found in functional somatic syndrome patients. Thus, treatment of UARS or OSA/H by use of airway stabilization techniques in accordance with the present invention is likely to treat the functional somatic syndromes.

The foregoing example further suggests that the continuum of upper airway collapsibility during sleep characterizes sleep disordered breathing causing different types of sleep disorders. For example, a high degree of inspiratory flow limitation during sleep is associated with moderate to severe OSA/H, while a lesser inspiratory flow limitation is associated with UARS. The use of an airway stabilization technique, whether a mechanical stabilization technique or a stabilization technique incorporating positive airway pressure therapy will address the symptom/signs of OSA/H or UARS and, therefore, the symptoms/signs of functional somatic syndrome. As indicated previously, the inventors believe that the frequent arousal and alpha wave intrusions into the sleep of patients with functional somatic syndromes and the non-restorative sleep associated with these syndromes may result from this inspiratory flow limitation. Treatment of inspiratory flow limitation may thus correct or modify the symptoms of functional somatic syndromes.

### EXAMPLE II

To further confirm the hypothesis regarding treating functional somatic syndromes through airway stabilization techniques, the inventors' conducted an additional study specifically on female fibromyalgia patients. Generally, the object of the study was to determine whether fibromyalgia patients have inspiratory airflow dynamics during sleep comparable to female UARS patients. The patients included twenty-eight (28) female fibromyalgia patients diagnosed by rheumatologists using established criteria. Fourteen (14) of the patients gave a history of snoring, while four (4) claimed to snore occasionally, and ten (10) denied snoring. The comparison group included eleven (11) female UARS patients matched for age and obesity. Eighteen (18) of the twenty-eight (28) fibromyalgia patients and all the UARS patients had a full-night polysomnogram. All patients had a nasal CPAP study with quantitative monitoring of inspiratory airflow and effort between atmospheric pressure and therapeutic CPAP. Fourteen (14) fibromyalgia patients and all UARS patients had a successful determination of pharyngeal critical pressure (Pcrit). Of the twenty-eight (28) female fibromyalgia patients, twenty-seven (27) had sleep disordered breathing. One patient of the twenty-seven (27) had obstructive sleep hypopnea (OSA/H), while twenty-six (26) of twenty-seven (27) patients had milder inspiratory airflow limitation with arousals. One (1) patient exhibited no OSA/H or inspiratory airflow limitation during sleep. While sleeping at atmospheric pressure, apnea/hypopnea index, arousal index, the prevalence of airflow limited breaths, and maximal and inspiratory airflow were comparable between groups. The Pcrit of female fibromyalgia patients was −6.5±3.5 cmH₂O (mean±SD) compared to −5.8±3.5 cmH₂O for female UARS patients (p=0.62). Treatment of fourteen (14) consecutive patients with nasal CPAP resulted in an improvement in functional symptoms ranging from 23% to 47% as assessed by a validated questionnaire. The results of this additional study indicate that inspiratory airflow limitation during sleep likely plays a primary role in the development of the functional somatic syndromes. Further details of the study are provided hereinafter.

As is known to those skilled in the art, fibromyalgia is one of the functional somatic syndromes and is generally present with the symptoms of fatigue, widespread body pain and tenderness, headache, heartburn, abdominal pain, bloating and diarrhea, cognitive deficits, depression, sleep onset and sleep maintenance insomnia. These subjective complaints of fibromyalgia patients are associated with the objective findings of alpha-wave intrusion into Stage 1 and 2 NREM sleep and alpha-delta sleep. Patients with fibromyalgia often receive a combination of psychotherapy, physical therapy, psychotropic medications and analgesics. The results of such treatments are generally limited and fibromyalgia patients often live with chronic insomnia, fatigue, and pain.

As indicated previously, a study sample of twenty-eight (28) pre-diagnosed female fibromyalgia patients took part in the inventors CPAP study. The twenty-eight (28) female fibromyalgia patients were required to complete a detailed medical and sleep related questionnaire before being evaluated by a physician board-certified in both Internal Medicine and Sleep Medicine. The physician performed a general medical and sleep related history. As indicated previously, full-night polysomnography was performed using standard methodology. Airflow at the nose and mouth was monitored with a thermocouple. Thoracoabdominal movement was monitored with piezoelectric belts. Oxyhemoglobin saturation was monitored at the finger using a pulse oximeter. Sleep was staged using the scoring system of Rechtschaffen and Kales with the modification of Flagg and Coburn for sleep disordered breathing. The presence of alpha-delta sleep was identified by the characteristic low frequency (<2 cycles/s) high amplitude (>75 microvolt peak to trough) delta waves with superimposed 7-11 cycle/s alpha waves. EEG arousals not associated with hypopnea or apnea were identified using the American Sleep Disorders Association Atlas Task Force criteria. For each patient, the total of arousals not associated with hypopnea or apnea was divided by the total sleep time to derive an arousal index (arousals/hr). The apnea/hypopnea index (AHI) was quantified for each patient. The diagnosis of OSA/H was established by an AHI of at least 10 events/hour sleep.

As also indicated previously, all twenty-eight (28) of the female fibromyalgia patients and eleven (11) female UARS patients had a nasal CPAP study. The study was performed to identify the presence of inspiratory airflow limitation at atmospheric pressure and to determine the appropriate CPAP to overcome the inspiratory airflow limitation. Each patient slept wearing a nasal CPAP mask connected to a source of pressure varying between +20 cmH₂O and −20 cmH₂O. Nasal airflow was measured with a heated pneumotachograph. Inspiratory effort was measured as the change in esophageal pressure using a balloon tipped catheter. Inspiratory airflow limitation during sleep at atmospheric pressure was considered to occur when inspiratory airflow reached a plateau despite an esophageal pressure that continued to decrease. When inspiratory airflow limitation was demonstrated at atmospheric mask pressure, the airflow dynamics were characterized by measuring both the maximal inspiratory airflow and the inspiratory esophageal pressure for five (5) to eight (8) consecutive breaths during continuous NREM sleep. To determine each patient's prevalence of airflow limited breaths at atmospheric pressure, a continuous period of approximately four (4) minutes of continuous sleep (no epochs of wakefulness during the period, but arousals were permitted) was utilized. Each breath during the period (including breaths during arousals) was evaluated by the criteria for airflow limitation and categorized as airflow-limited or non-airflow limited. The prevalence of airflow-limited breaths was determined by dividing the total of airflow limited breaths by the total of breaths during the period. The mask pressure was then raised in increments (1 cmH₂O), while inspiratory airflow and effort was monitored until inspiratory airflow limitation was abolished and the esophageal pressure was minimized. This level of mask pressure was determined to be the therapeutic CPAP. For each fibromyalgia patient, the study attempted to determine the nasal mask pressure at which the upper airway occludes during NREM sleep (Pcrit; an index of upper airway collapsibility). In addition, a calculation was made for the resistance upstream to the site of airflow limitation.

All fibromyalgia patients treated with nasal CPAP during sleep completed a self-report, functional symptom questionnaire, before and after three (3) weeks of nasal CPAP treatment, during which at least five (5) hours of use per night was requested. Compliance with treatment was assessed by patient report. Functional symptoms were evaluated in accordance with standard medical practice.

While breathing at atmospheric pressure during the nasal CPAP study, twenty-six (26) of the twenty-seven (27) fibromyalgia patients without OSA/H experienced inspiratory airflow limitation during NREM sleep. The present inventor sampled 61±17 consecutive breaths at atmospheric pressure per patient and found a prevalence of airflow limited breaths of 90±13%. Therefore, inspiratory airflow limitation was the prevalent breathing pattern during sleep among the female fibromyalgia patients. The mean maximal inspiratory airflow for the fibromyalgia patients with inspiratory airflow limitation was 169±90 ml/s and the mean inspiratory change in esophageal pressure was 13±9 cmH₂O. The therapeutic CPAP pressure was 7±2 cmH₂O. At the therapeutic pressure, the mean inspiratory esophageal pressure for the group was 6±5 cmH₂O representing a 7 cmH₂O decrease in inspiratory effort from a mask pressure of atmospheric pressure. The nasal CPAP findings confirm that the 30.0±13.7 arousals/hr experienced by the eighteen (18) fibromyalgia patients who underwent full-night polysomnography were respiratory event related arousals (RERA's).

The upper airway airflow dynamics during sleep of the female UARS patients were comparable to those of the female fibromyalgia patients. Compared to the female fibromyalgia patients, the female UARS patients had similar values of AHI and arousal index. Their values of maximal inspiratory airflow under conditions of inspiratory airflow limitation during NREM sleep were similar. Their values of therapeutic pressure were similar. There were statistically non-significant trends toward a lower esophageal pressure and a higher calculated resistance upstream to the site of airflow limitation in the fibromyalgia patients compared to the UARS patients. The present inventor sampled 58±18 consecutive breaths at atmospheric pressure per female UARS patient and found a prevalence of low limited breaths of 91±12% (a prevalence nearly identical to that of the female fibromyalgia patients).

The treatment of functional symptoms with nasal CPAP was successful in the female fibromyalgia patients that chose to try nasal CPAP treatment. In particular, the female fibromyalgia patients demonstrated a 46% improvement in fatigue, a 38% improvement in pain, a 39% improvement in sleep problems, and a 47% improvement of GI symptoms after three (3) weeks of nasal CPAP treatment. The three (3) weeks of nasal CPAP treatment also decreased the level of functional disability and distress experienced by the patients. Functional disability decreased by 23%. Distress as represented by the rheumatology distress index decreased 33% from 62.8 to 42.2. Further, of the fourteen (14) female fibromyalgia patients who tried nasal CPAP treatment, five (5) (36%) remained on nasal CPAP nine (9) months to twenty-one (21) months after the study concluded.

In summary, the foregoing example of female fibromyalgia patients and female UARS patients indicated a definite link between inspiratory airflow limitation during sleep in 96% of female fibromyalgia patients. Only 4% of female fibromyalgia patients had OSA/H. The remaining 92% had higher levels of maximal inspiratory airflow during sleep characteristic of female UARS patients. Parameters describing sleep disordered breathing and inspiratory airflow dynamics, such as AHI, arousal index, prevalence of airflow limited breaths during sleep were comparable between fibromyalgia patients and female UARS patients. Treatment of the female fibromyalgia patients' inspiratory airflow limitation during sleep with nasal CPAP resulted in an improvement in their functional symptoms, as indicated previously. The study clearly demonstrates that inspiratory airflow limitation during sleep is commonly observed in female fibromyalgia patients, and treatment with nasal CPAP improved the symptoms associated with the female fibromyalgia patients in the study.

Each of the foregoing examples relate to studies on a sample of patients with one or more functional somatic syndromes. The inventor's second study concentrated on a specific functional somatic syndrome, fibromyalgia. Each of the studies demonstrates that a high prevalence of inspiratory airflow limitation during sleep accompanies the functional somatic syndromes. The second study (Example II) firmly demonstrated that treatment with nasal CPAP improves functional symptoms in fibromyalgia patients. In particular, nasal CPAP treatment improves functional symptoms when inspiratory airflow limitations are prevented with nasal CPAP. Each of these examples supports the inventors' conclusion that inspiratory airflow limitation during sleep plays a primary role in development of the functional somatic syndromes, and treatment with an airway stabilization technique in accordance with the present invention improves the symptoms/signs associated with the functional somatic syndromes.

Moreover, in view of the similarity between symptoms/signs of UARS patients and functional somatic syndrome patients, the identification of a patient as having a functional somatic syndrome or one or more symptoms/signs associated therewith may be used in accordance with the present invention to diagnose the UARS and OSA/H sleep disorders. Once it is determined that a patient suffers from one or more symptoms of a functional somatic syndrome and the diagnosis of sleep-disordered breathing is made, the various airway stabilization techniques described previously may be used to treat the patient.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims.

The invention claimed is:

1. A method of treating functional somatic syndromes comprising the steps of:
identifying a patient as having a functional somatic syndrome; and
treating such a patient with an airway stabilization technique.

2. The method as claimed in claim 1, wherein treating such a patient with an airway stabilization technique comprises stabilizing the airway with a mechanical stabilization.

3. The method as claimed in claim 2, wherein the mechanical stabilization is selected from the group consisting of:
an oral appliance adapted to control a position of an anatomical feature of a patient;
a tissue distending device adapted to be located externally and coupled to such a patient so as to distend tissue associated with such a patient's airway; and
a stimulation device adapted to apply a stimulating energy to a patient.

4. The method as claimed in claim 1, wherein treating such a patient with an airway stabilization technique comprises stabilizing the airway with positive airway pressure therapy.

5. The method as claimed in claim 4, wherein the positive airway pressure therapy is selected from the group consisting of: continuous positive airway pressure, bi-level positive airway pressure, and auto-titrating positive airway pressure.

6. The method as claimed in claim 1, wherein identifying a patient as having a functional somatic syndrome includes identifying a symptom of the functional somatic syndrome, wherein the symptom is selected from the group consisting of: chronic fatigue, irritable bowel, migraine headaches, tension headaches, temporomandibular joint pain, premenstrual pain, sleep-onset insomnia, sleep maintenance insomnia, unrefreshing sleep, EEG evidence of sleep fragmentation, bruxism, muscle pain, muscle tenderness, heartburn, abdominal pain, abdominal urgency, diarrhea, depression, orthostatic syncope, alpha-delta sleep.

7. The method as claimed in claim 1, further comprising the step of monitoring such a patient for an inspiratory airflow limitation.

8. The method as claimed in claim 7, further comprising the step of categorizing a patient who has an inspiratory airflow during sleep of approximately fifty-one to one-hundred percent of waking levels as an upper airway resistance syndrome (UARS) patient.

9. The method as claimed in claim 7, further comprising the step of categorizing a patient who has an inspiratory airflow during sleep of approximately zero to fifty percent of waking levels as an obstructive sleep apnea/hypopnea (OSA/H) patient.

10. The method as claimed in claim 1, further comprising observing alpha-delta sleep of such a patient to diagnose the functional somatic syndrome.

11. The method as claimed in claim 1, wherein the functional somatic syndrome is selected from the group consisting of: chronic fatigue syndrome, fibromyalgia, irritable bowel syndrome, migraine headaches, tension headaches, temporomandibular joint syndrome, Gulf War syndrome, premenstrual syndrome, sleep-onset insomnia, sleep maintenance insomnia, multiple chemical sensitivity, sick building syndrome, repetition stress injury, side effects of silicone breast implants, chronic whiplash, and restless leg/periodic limb movement syndrome.

12. A method of treating functional somatic syndromes comprising the steps of:
identifying a patient as having one or more symptom of a functional somatic syndrome; and
treating such a patient with an airway stabilization technique.

13. The method as claimed in claim 12, wherein treating such a patient with an airway stabilization technique comprises stabilizing the airway with a mechanical stabilization.

14. The method as claimed in claim 13, wherein the mechanical stabilization is selected from the group consisting of:
an oral appliance adapted to control a position of an anatomical feature of a patient;
a tissue distending device adapted to located externally and coupled to such a patient so as to distend tissue associated with such a patient's airway; and
a stimulation device adapted to apply a stimulating energy to a patient.

15. The method as claimed in claim 12, wherein treating such a patient with an airway stabilization technique comprises stabilizing the airway with positive airway pressure therapy.

16. The method as claimed in claim 15, wherein the positive airway pressure therapy is selected from the group consisting of: continuous positive airway pressure, bi-level positive airway pressure, and auto-titrating positive airway pressure.

17. The method as claimed in claim 1, wherein the symptom of the functional somatic syndrome is selected from the group consisting of: chronic fatigue, irritable bowel, a migraine headache, a tension headache, temporomandibular joint pain, premenstrual pain, sleep-onset insomnia, sleep maintenance insomnia, unrefreshing sleep, EEG evidence of sleep fragmentation, bruxism, muscle pain, muscle tenderness, heartburn, abdominal pain, abdominal urgency, diarrhea, headaches, depression, orthostatic syncope, alpha-delta sleep.

18. The method as claimed in claim 12, further comprising the step of monitoring such a patient for an inspiratory airflow limitation during sleep.

19. The method as claimed in claim 18, further comprising the step of categorizing a patient who has an inspiratory airflow of approximately fifty-one to one-hundred percent of waking levels as an upper airway resistance syndrome (UARS) patient.

20. The method as claimed in claim 18, further comprising the step of categorizing a patient who has an inspiratory airflow limitation of approximately zero to fifty percent of waking levels as an obstructive sleep apnea/hypopnea (OSA/H) patient.

21. A method of diagnosing a sleep disorder comprising the steps of:
determining whether a patient suffers from one or more symptoms of a functional somatic syndrome; and
diagnosing such a patient as having sleep-disordered breathing.

22. The method as claimed in claim 21, further comprising the steps of diagnosing the patient as a moderate to severe obstructive sleep apnea/hypopnea (OSA/H) patient if alpha-delta sleep is not substantially present, and treating such a patient with an airway stabilization technique.

23. The method as claimed in claim 21, further comprising the steps of diagnosing the patient as an upper airway resistance syndrome (UARS) or mild to moderate obstructive sleep apnea/hypopnea (OSA/H) patient if alpha-delta sleep is substantially present and treating such a patient with an airway stabilization technique.

24. The method as claimed in claim 21, further comprising treating such a patient with an airway stabilization technique.

25. The method as claimed in claim 24, wherein the airway stabilization technique comprises stabilizing the airway with a mechanical stabilization, the mechanical stabilization selected from the group consisting of:
an oral appliance adapted to control a position of an anatomical feature of a patient;
a tissue distending device adapted to be located externally and coupled to such a patient so as to distend tissue associated with such a patient's airway; and
a stimulation device adapted to apply a stimulating energy to a patient.

26. The method as claimed in claim 24, wherein treating such a patient with an airway stabilization technique comprises stabilizing the airway with positive airway pressure therapy.

27. The method as claimed in claim 26, wherein the positive airway pressure therapy is selected from the group consisting of: continuous positive airway pressure, bi-level positive airway pressure, and auto-titrating positive airway pressure.

28. The method as claimed in claim 21, wherein the one or more symptoms of a functional somatic syndrome is selected from the group consisting of: chronic fatigue, irritable bowel, migraine headaches, tension headaches, temporomandibular joint pain, premenstrual pain, sleep-onset insomnia, sleep maintenance insomnia, unrefreshing sleep, EEG evidence of sleep fragmentation, bruxism, muscle pain, muscle tenderness, heartburn, abdominal pain, abdominal urgency, diarrhea, depression, orthostatic syncope, alpha-delta sleep.
